(19) United States
(12) Patent Application Publication
(10) Pub. No.: US 2021/0123406 A1
(43) Pub. Date: Apr. 29, 2021

(54) Coupling Device For Transmitting Torque From A Gyrating Mass To A Drive Device And Corresponding Method

(71) Applicant: ZF Friedrichshafen AG, Friedrichshafen (DE)

(72) Inventors: Wolfgang KUNDERMANN, Dornburg-Dorndorf (DE); Wolfgang GROSSPIETSCH, Schweinfurt (DE); Axel ROHM, Schonungen (DE); Steffen MATSCHAS, Bad Bocklet (DE)

(21) Appl. No.: 16/617,418

(22) PCT Filed: May 8, 2018
(86) PCT No.: PCT/EP2018/061749

§ 371 Date: Nov. 26, 2019

(30) Foreign Application Priority Data
Jun. 2, 2017 (DE) 10 2017 209 455.9

(51) Int. Cl. F02N 5/04; F02N 15/02; F02N 7/06

(52) U.S. Cl. CPC F02N 5/04; F02N 7/06; F02N 15/027

(57) ABSTRACT

A coupling device for transmitting a torque from a flywheel mass to a drive device. A ratchet wheel and a transmission element of the flywheel mass ‘SUE’, which is identical to the flywheel mass (or is connected to the flywheel mass, are axially displaceable relative to one another, and pawls of the ratchet wheel can be moved into cutouts of the SUE, and a friction device, particularly in the form of a friction cone, is connectable to the SUE at least partially in a frictionally engaging manner and is connected to the ratchet wheel in a positively engaging manner.

### CROSS REFERENCE TO RELATED APPLICATIONS

This is a U.S. national stage of Application No. PCT/EP2018/061749 filed May 8, 2018. Priority is claimed on German Application No. DE 10 2017 209 455.9 filed Jun. 2, 2017 the content of which is incorporated herein by reference.

### BACKGROUND OF THE INVENTION

### 1. Field of the Invention

The invention is directed to a coupling device for transmitting a torque from a flywheel mass to a drive device. The invention is further directed to a damping device comprising a housing, a coupling device, a first damping device, a drive transmission element, and an output transmission element. The invention is further directed to a method for transmitting a torque from a flywheel mass to a drive device by a coupling device. Although the present invention is applicable in general to any vehicles and drive devices, the present invention is described with reference to hybrid vehicles with a drive device in the form of an internal combustion engine and an electric motor.

### 2. Description of Related Art

Hybrid vehicles driven by at least one electric motor and a further energy converter, for example, in the form of an internal combustion engine, are used to reduce fossil fuel consumption and to improve efficiency. In hybrid vehicles, the electric motor is initially utilized in a known manner for starting the hybrid vehicle, and the internal combustion engine is started or switched on only after a determined speed, for example, a speed between 7 and 20 km/h. A starter is usually required for starting the internal combustion engine. It is known that the starting process for the internal combustion engine by starters is disadvantageous with regard to starting time and consumption. In order to solve this problem, it has been suggested to start the internal combustion engine by a momentum start device so that the starter can be omitted and the internal combustion engine can be started more efficiently.

A momentum start arrangement in which a rotor is constructed as flywheel mass and can start the internal combustion engine when a disconnect clutch is engaged is known from DE 37 37 229 A1.

A further momentum start arrangement in which a flywheel mass is responsible for starting the internal combustion engine is known from EP 09 66 627 B1. The flywheel mass can be uncoupled from the internal combustion engine on one hand and from the transmission on the other hand via a clutch, respectively. If the internal combustion engine is to be started, both clutches are opened and the flywheel mass is accelerated via an electric motor. When the necessary rotational speed is reached, the clutch between the flywheel mass and the internal combustion engine is closed and the motor is started. The length of time for starting the internal combustion engine is particularly disadvantageous in this case.

Further, a positively engaging and frictionally engaging clutch for starting the internal combustion engine is known from DE 10 2015 201 931 A1 and is arranged on a shaft between the internal combustion engine and electric motor. If the hybrid vehicle is driven by means of the electric motor and if the internal combustion engine is to be switched on, the latter is started additionally by torque transmission through a frictional force engagement element of the clutch device. A drawback consists in that the positive engagement element cannot be brought to positive engagement for transmitting torque until frictional force engagement is already present by means of the frictional force engagement element. Therefore, the frictional force engagement element is exclusively controlled by frictional force. A further disadvantage consists in the extensive installation space demanded by the parallel connection of the positive engagement element and frictional force engagement element.

### SUMMARY OF THE INVENTION

It is therefore an object of one aspect of the present invention to provide a coupling device for transmitting a torque from a flywheel mass to a drive device that provides a connection of a rotating flywheel mass to an internal combustion engine for starting the motor, and the starting of the internal combustion engine should be carried out within a definite period of time, and the integration of the coupling device into an existing drive system should be carried out so as to affect installation space as little as possible.

According to one aspect of the invention in a coupling device for transmitting a torque from a flywheel mass to a drive device in that a ratchet wheel and a transmission element of the flywheel mass ‘SUE’ which is identical to the flywheel mass or is connected to the flywheel mass are axially displaceable relative to one another such that pawls of the ratchet wheel can be moved into cutouts of the SUE and a friction device, particularly in the form of a friction cone, is connectable to the SUE at least partially in a frictionally engaging manner on the one hand and is connected to the ratchet wheel in a positively engaging manner on the other hand.

One aspect of the invention is a damping device comprising a housing, a coupling device according to one of claims 1 to 15, a first damping device particularly in the form of a torsional damper, a drive transmission element particularly in the form of a crankshaft hub, and an output transmission element particularly in the form of a hub disk, and the SUE is configured as primary element, particularly as primary plate, of the damping device.

One aspect of the invention is a method for transmitting a torque from a flywheel mass to a drive device by a coupling device in that a ratchet wheel and a transmission element of the flywheel mass ‘SUE’, which is identical to the flywheel mass or is connected to the flywheel mass, are displaced axially relative to one another such that pawls of the SUE are brought into engagement relative to one another for transmitting torque and such that, before an engagement of the pawls by a friction device, torque is transmitted from the SUE to the ratchet wheel by an at least partial frictionally engaging connection between SUE and friction device on one hand and by a positively engaging connection between SUE and ratchet wheel on the other hand.

One of the advantages achieved in this way consists in that the coupling device transmits a torque before an internal combustion engine, for example, is fired or started. A further advantage consists in that a positively engaging locking element is provided for transmitting torque instead of a friction force-controlled locking element. Accordingly, the accuracy and reliability during the transmission of torque is improved. A further advantage is that the pawls of the ratchet wheel can engage in/merge with the cutouts of the SUE provided there is a differential speed between the flywheel mass on the one hand and the drive device on the other hand. A further advantage consists in the compact installation space.

In other words, one aspect of the invention provides a coupling device, wherein the friction device initiates synchronization and the ratchet/pawl mechanism is dispensed with, for example, as a result of the differential speed defined by the geometry and control force. In so doing, the ratchet engages before the internal combustion engine is fired; this makes it possible to start the motor within a defined time period.

Further features, advantages and further embodiment forms of the invention are described in, or may be disclosed by, the following:

An actuating device for reducing the axial distance between the ratchet wheel and SUE is advantageously arranged and comprises a piston and a spring device for the piston. This allows a simple and reliable actuation of the coupling device, for example, by application of pressure to the piston. The spring device allows a further tuning of a threshold for the actuation of the piston and also provides a function for retaining the piston in its respective position.

Advisably, the piston can be actuated by hydraulic pressure, in particular a piston nozzle is arranged for the piston, and the piston is arranged to contact the friction device, particularly the friction cone, for transmission of force. One of the advantages achieved in this way is to allow a compact arrangement of the control of the piston by hydraulic pressure. The hydraulic fluid can then flow back via the piston nozzle.

The ratchet wheel and/or the friction device itself are advantageously configured for actuation by hydraulic pressure. This increases reliability because separate parts such as pistons, etc. can be dispensed with.

Spring elements are advisably arranged. These spring elements have first areas arranged between the ratchet wheel and cutouts of the SUE, and the shape of the spring elements is configured to receive the pawls. An advantage of this is that it allows backlash-free transmission of force between SUE and ratchet wheel as well as tolerance compensation and a damping of the impact when the pawls of the ratchet wheel engage in the SUE.

The spring elements advantageously have second areas which are arranged between friction device and SUE. One of the advantages achieved in this way consists in that the spring elements, e.g., in the form of spring plates, accordingly form an opposing friction surface in the friction device. The SUE can then be produced from a “soft” deep-drawable material.

The spring elements are advisably arranged on the SUE side. The advantage here is that these spring elements can be arranged in a reliable manner.

The spring elements advantageously extend at least partially at a flat angle relative to at least one of the lateral surfaces of the pawls and/or the lateral surfaces of the cutout. This is advantageous in that a sliding bearing effect is provided, which prevents or at least mitigates a premature engagement of the pawls in the cutouts.

The spring elements are advisably formed asymmetrically; in particular, the spring elements extend at a flat angle on the side directed away from a rotational direction. This allows a transmission of force between ratchet wheel and SUE that is particularly free from backlash. In particular, the spring element has a planar contact in the cutouts on the drive side and a contact with flat spring angle on the coast side with respect to a rotational direction of the motor.

The surface region of the SUE surrounding a cutout is advantageously beveled. An improved sliding bearing effect is made possible in this way.

The surface region of the SUE surrounding the cutout is advisably rounded at the transition between surface region and cutout, particularly on the side directed away from a rotational direction. This makes possible a particularly soft engagement coupling. The rounded region can have the shape of a tractrix such as would arise, for example, as a result of wear on “soft parts”.

Cutouts and ratchet wheel are advantageously configured so as to correspond to one another but so as to be asymmetrical. In other words, the cutout in the SUE and the pawls at the ratchet wheel are asymmetrical, for example, configured to be planar on the drive side and inclined on the coast side. One of the advantages achieved in this way consists in that it allows a toothing which is free from backlash or at least has minimal backlash. A further advantage consists in that axial restoring forces are enabled from the inclination only from low coasting torque.

The SUE is advisably supported by at least one sliding bearing, particularly two sliding bearings. This allows a particularly reliable bearing support of the SUE, for example, on a shaft.

The at least one sliding bearing advisably provides a pressure restriction effect and/or the at least one sliding bearing is provided in the form of a rolling bearing/sliding bearing combination and a rectangular seal. In this way, a restriction effect can be provided for the actuation pressure of the coupling device in a simple and simultaneously reliable manner.

A spring element is advisably arranged between the ratchet wheel of the coupling device and the drive transmission. One of the advantages achieved in this way consists in that axial backlash compensation is provided.

The spring element is advisably configured in the form of a radial shaft spring plate. The advantage here consists in that a spring element can be provided for axial backlash compensation in a simple and economical manner.

The primary element advantageously has a rotary seal, particularly in the form of a radial shaft sealing ring, for sealing relative to the drive transmission element. In this way, various sealed pressure spaces can be provided in a simple manner and excessive leakage of hydraulic fluid, particularly oil, is prevented.

The housing is advantageously partially formed by a vertical wall of a drive mechanism, and the wall has a rotary seal for sealing. This allows a compact arrangement of the damping device, since a completely separate housing can be dispensed with.

The housing is advisably partially formed by a bell housing which is connected to the vertical wall of the drive device, and a seal is arranged partially between the vertical wall of the drive device and the bell housing. The advantage here consists in that integration in a transmission is made possible in a particularly simple manner aside from the partial omission of a separate housing.

The housing is advantageously formed on the secondary side of the damping device by a bearing shield, the SUE of the coupling device being supported relative to the bearing shield. The advantage here consists in the reliable bearing support of the SUE.

The housing, particularly the bearing shield, advisably has at least one channel for the pressure supply line for the hydraulic actuation of the coupling device. The advantage here consists in that a particularly compact and reliable pressure supply line of a hydraulic fluid for actuating the coupling device is provided.

The bearing shield advantageously has an opening for receiving a hydraulic connection and a compensation element for compensating movements of the drive, particularly wherein the compensation element is constructed as a rubberized intermediate layer or the like. This makes possible a simple and economical compensation element for movements, for example, of the crankshaft. Further, a flexible receiving of a hydraulic connection is provided.

The housing advisably has return channels for a hydraulic fluid, particularly oil. The advantage here consists in that no external hoses, etc. need be used and, accordingly, a particularly compact and reliable return is made possible.

The SUE is advantageously connected to a speed-adaptive damper and/or a second torsional damper and/or a clutch element such as an inner plate carrier or the like. This enables a particularly high flywheel mass, which facilitates starting of an internal combustion engine.

The two areas on both sides of the coupling device, particularly on both sides of the ratchet wheel, are advisably acted upon by different pressure of a hydraulic fluid, and both areas are constantly acted upon by a minimum pressure of a hydraulic fluid. One of the advantages achieved thereby consists in that an actuation of the coupling device by means of pressure differences is made possible. Provided the minimum pressure is not zero, a layer of hydraulic fluid is also formed particularly between the ratchet wheel and the SUE, which provides a kind of sliding bearing effect which prevents a premature engagement or actuation of the coupling device in particular.

Further important features and advantages of the invention will be apparent from the subclaims, the drawings and associated description of the figures referring to the drawings.

It will be appreciated that the features mentioned above as well as those to be described in the following may be used not only in any of the combinations indicated but also in other combinations or individually without departing from the scope of the present invention.

### BRIEF DESCRIPTION OF THE DRAWINGS

Preferred constructions and embodiment forms of the invention are shown in the drawings and are described more fully in the following description Like reference numerals designate like or similar or functionally like component parts or elements.

The drawings show schematically and in section:

FIG. 1 is a damping device;

FIGS. 2a, 2b is a damping device according to FIG. 1 showing an open (FIG. 2a) and closed (FIG. 2b) coupling device;

FIG. 3 is a damping device;

FIG. 4 is a damping device;

FIG. 5 is a damping device;

FIG. 6 is a damping device;

FIG. 7 is a damping device;

FIGS. 8a, 8b is a damping device;

FIG. 9 is a damping device;

FIG. 10 is a damping device;

FIGS. 11a, 11b, 11c are various conditions and configurations of the coupling device;

FIGS. 12a, 12b is a coupling device;

FIGS. 13a, 13b, 13c is a coupling device; and

FIGS. 14a, 14b are various conditions and configurations of a coupling device;

FIG. 15 are parts of a damping device shown schematically and three-dimensionally; and

FIG. 16 are parts of a damping device shown schematically and three-dimensionally.

### DETAILED DESCRIPTION OF THE PRESENTLY PREFERRED EMBODIMENTS

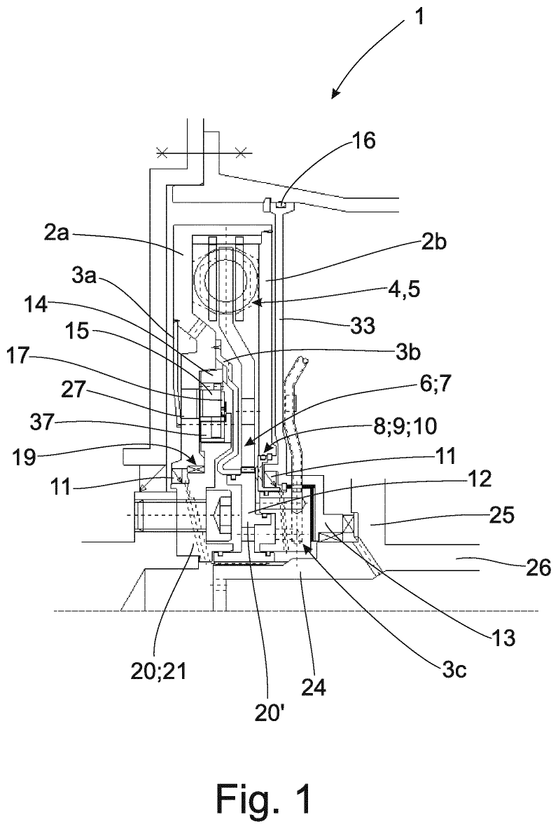

FIG. 1 shows a damping device according to an embodiment form of the present invention.

A damping device 1 in a drivetrain of a hybrid vehicle is shown in detail in FIG. 1. The damping device 1 is connected to a drive element 20 in the form of a crankshaft hub having an outer toothing 21. The outer toothing 21 of the crankshaft hub 20 engages in a corresponding inner toothing of a ratchet wheel 15 for transmitting torque. The SUE is arranged and configured in this case directly as flywheel mass in the form of a primary plate 2a, 2b which is supported on the crankshaft hub 20 via a sliding bearing 19. The motor-side area of the primary plate is designated by reference numeral 2a, and the transmission-side area is designated by reference numeral 2b. Further, a radial shaft sealing ring 11 is arranged between crankshaft hub 20 and primary plate 2a, 2b. The primary plate 2a has cutouts 27 that correspond to pawls 15a of the ratchet wheel 15. In other words, pawls 15a of the ratchet wheel engage in cutouts 27 of the primary plate 2a, 2b and transmit torque.

The ratchet wheel 15 has an outer toothing on its radial outer side that engages with an inner toothing of a friction cone 14. The friction cone 14 in turn communicates with the primary plate 2a at least partially in frictional engagement. The primary plate 2a, 2b in turn forms the primary side of a torsional damper 4. As is customary, the torsional damper 1 has a spring set 4 and corresponding cover plates 5. The spring set of torsional damper 4 is connected in a known manner to a torsional damper hub 12 via a hub disk 6 and a spline 7. A cover 3b is arranged between the hub disk 6 and the ratchet wheel 15 or friction cone 14 and, together with a cover 3a which covers the cutouts 27 and a portion of the primary plate 2a on the motor side, provides a pressure space for the coupling device. The primary plate 2a, 2b which is U-shaped in this instance substantially surrounds spring set 4 and the hub disk 6 laterally and radially above spring set 4. To this end, the primary plate 2a, 2b has a corresponding covering on the drive side as well as on the transmission side. In the area of the torsional damper hub 12, the area of primary plate 2b arranged on the transmission side is fixed thereto with a closure cover 8 and with an O-ring 9 and a snap ring 10. A radial shaft sealing ring 11 is arranged between closure cover 8 and a bearing shield 33 extending in radial direction. The bearing shield 33 in turn has a further seal 16 at its radial outer side for sealing relative to further transmission parts, for example, a speed-adaptive damper or the like. Further covers 3c, which perform a bearing function on the one hand and serve to connect a hydraulic fluid pressure line or the like on the other hand, are arranged in the area of the torsional damper hub 12. Torsional damper hub 12 and crankshaft hub 20 are supported on an input shaft 24, which has connections 25, 26 downstream of the damping device with respect to torque for connecting a speed-adaptive damper and/or an inner plate carrier or the like. A radial shaft spring plate 37 is arranged between outer toothing 21 of crankshaft hub 20 and ratchet wheel 15 to compensate for axial tolerances.

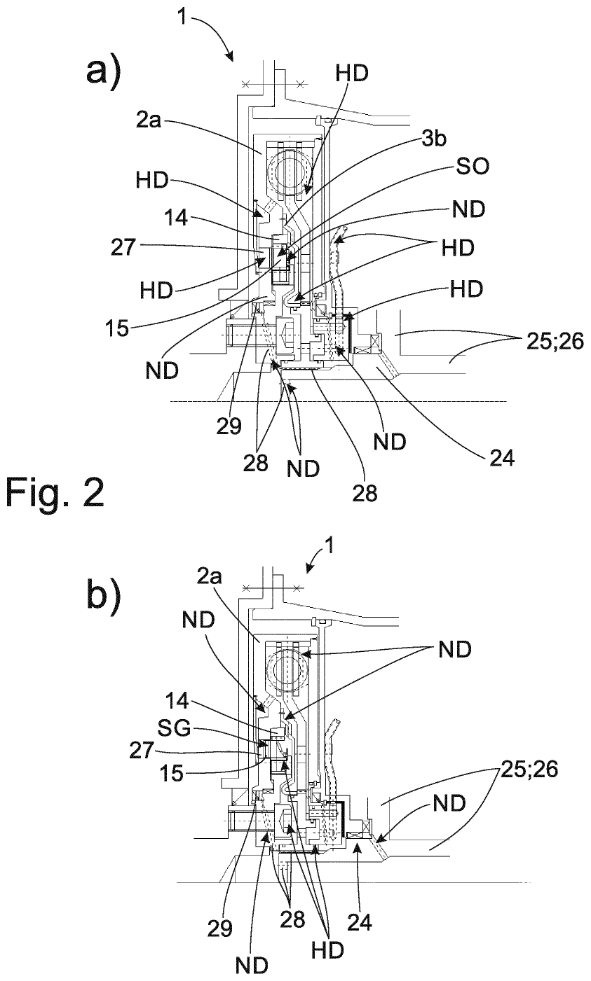

FIGS. 2a, b show a damping device according to FIG. 1 with open (FIG. 2a) and closed (FIG. 2b) coupling device.

FIGS. 2a and 2b basically show a damping device according to FIG. 1. The open position SO of the coupling device in which the ratchet wheel 15 does not engage with the primary plate 2a, 2b is shown in FIG. 2a, while the closed position SG of the coupling device in which ratchet wheel 15 engages with the primary plate 2a, more accurately in which the pawls 15a engage in cutouts 27 of the primary plate 2a, is shown in FIG. 2b.

In the open position SO, the area designated by reference character HD is acted upon by oil under high pressure. Basically, this refers to the areas between the transmission-side primary plate 2b, spring set 4 of the torsional damper and primary plate 2a, including cutouts 27. The low-pressure area ND is substantially formed by leakage oil returns 28 in the area of the crankshaft hub 20 and the areas of friction cone 14 and ratchet wheel 15 on the remote side of the cutouts 27 of primary plate 2a. The higher oil pressure in the cutouts 27 prevents the ratchet wheel 15 from engaging in the cutouts 27.

In the closed position SG according to FIG. 2b, the areas of high pressure HD and low pressure ND substantially switch. If the area of the friction cone 14 and ratchet wheel 15 remote of the cutouts 27 of primary plate 2a is acted upon by higher oil pressure than the area of the cutouts 27, the pressure difference causes the ratchet wheel 15 to be pressed in direction of the primary plate 2a and the friction cone 14 is brought into axial contact with the primary plate 2a. Accordingly, torque can then be transmitted correspondingly from the primary plate 2a ultimately to the crankshaft 20.

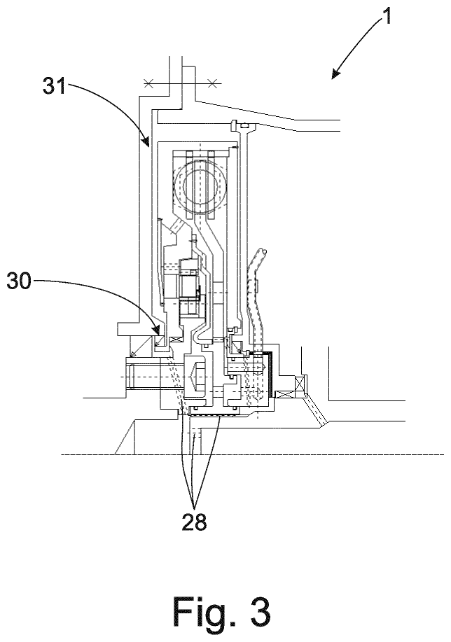

FIG. 3 shows a damping device according to a further embodiment form of the present invention.

FIG. 3 basically shows a damping device 1 according to FIG. 1. In contrast to the damping device 1 according to FIG. 1, the rotary seal 11 in the form of the radial shaft ring at the primary plate 2a can be omitted in the damping device 1 according to FIG. 3. Instead, a corresponding rotary seal 30 is arranged toward primary plate 2a between a vertical motor rear wall 31 in order to achieve a corresponding seal. Further, leakage oil returns 28 via the crankshaft hub 20, a toothing of an input shaft 24 and possibly further additional boreholes in the wet space are depicted by a dashed line.

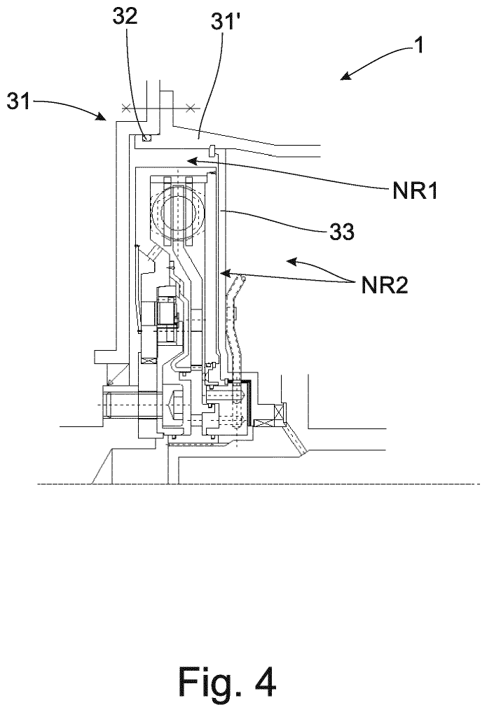

FIG. 4 shows a damping device according to a further embodiment form of the present invention.

FIG. 4 basically shows a damping device 1 according to FIG. 3. In contrast to the damping device 1 according to FIG. 3, the rotary seal 30 in the damping device 1 according to FIG. 4 is arranged through a seal 32 between motor rear wall 31 and a bell housing 31′. This defines a first wet space NR1 of torsional damper 4 and coupling element between motor rear wall 31 and transmission, wherein the return is carried out via a bearing shield 33 into the transmission. Accordingly, the bearing shield 33 separates the first wet space NR1 from the wet space of the transmission NR2.

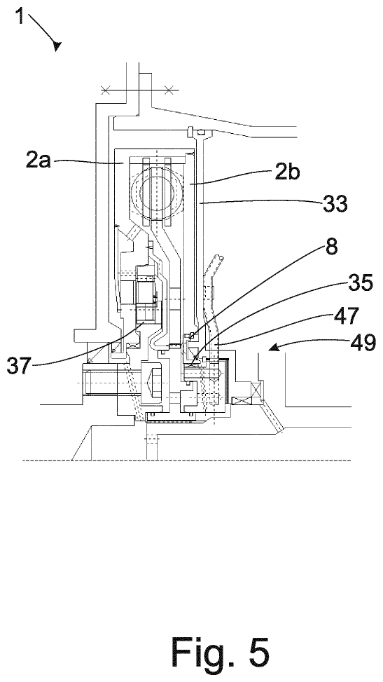

FIG. 5 shows a damping device according to a further embodiment form of the present invention.

FIG. 5 basically shows a damping device 1 according to FIG. 1. In the damping device 1 according to FIG. 5, in contrast to the damping device 1 according to FIG. 1, the closure cover 8, which is fixed to the transmission-side portion of the primary plate 2b via an O-ring 9 and snap ring 10 is supported on the transmission side in the area of a hydraulic connection 47, 49 by a bearing 35 relative to the transmission-side bearing shield 33 in addition to the bearing support at the crankshaft hub 20. Bearing support 35 is preferably constructed as a sliding bearing, the latter providing a pressure restricting effect. Bearing support 35 can also be constructed as a combination of a rolling element bearing and a rectangular ring seal.

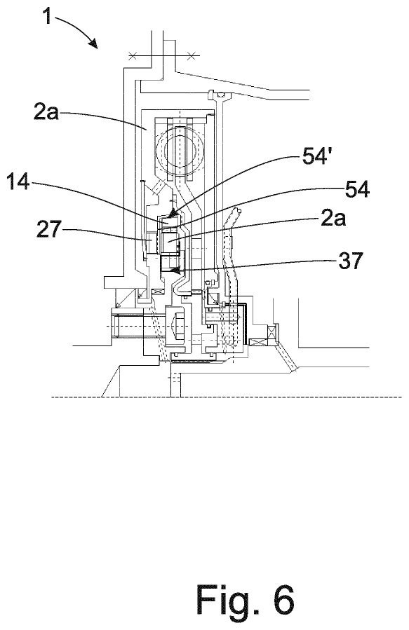

FIG. 6 shows a damping device according to a further embodiment form of the present invention.

FIG. 6 basically shows a damping device 1 according to FIG. 5. In the damping device 1 according to FIG. 6, in contrast to the damping device 1 according to FIG. 5, a spring plate 54 is arranged between ratchet wheel 15 and cutouts 27 of primary plate 2a for backlash-free force transmission, tolerance compensation and/or for damping an engagement impact of the pawls 15a in cutouts 27. The spring plate 54 can also be arranged in the area 54′ of the friction cone 14 in such a way that the latter forms an opposing friction surface in the friction cone 14. One of the advantages achieved by this consists in that the primary plate 2a, 2b can be produced from deep-drawable material.

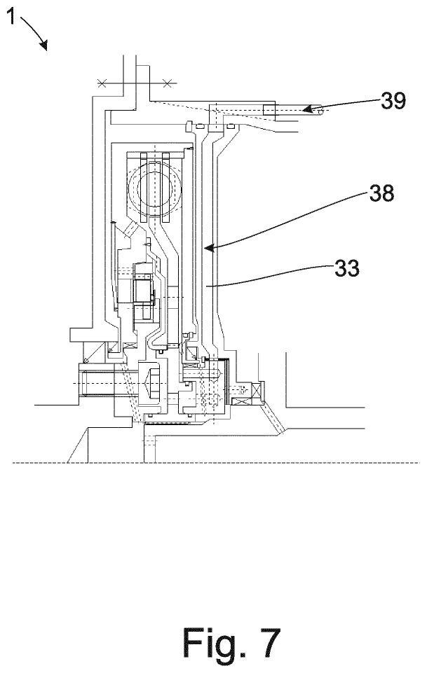

FIG. 7 shows a damping device according to a further embodiment form of the present invention.

FIG. 7 basically shows a damping device 1 according to FIG. 5. In the damping device 1 according to FIG. 7, in contrast to the damping device 1 according to FIG. 5, channels 38 are arranged in the bearing shield 33 for connecting a hydraulic pressure supply line 39, for example, from the transmission housing with external feed, for example, in the form of a hose line and/or pipe line.

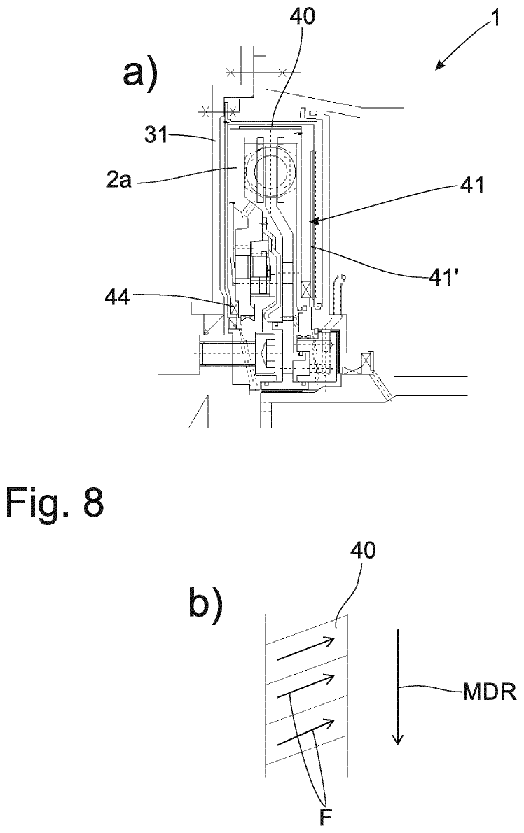

FIGS. 8a, b show a damping device according to a further embodiment form of the present invention (FIG. 8a) and a detail of the damping device according to FIG. 8a (FIG. 8b).

FIG. 8a basically shows a damping device 1 according to FIG. 1. In the damping device 1 according to FIG. 8, in contrast to the damping device 1 according to FIG. 1, a housing 41 for this damping device 1 is arranged for screwing to the motor rear wall 31. The housing 41 has channels 41′ for the internal leakage oil return. Further, housing 41 is supported on the motor side in the area of the primary plate bearing at crankshaft hub 20 by a bearing support 44. Further, as is shown in FIG. 8b, blades 40 are arranged on the radial outer side of the primary plate 2a—that is, basically at the radial outer side of the housing for the torsional damper with spring set 4 and hub disk 6 in order to control the oil flow F corresponding to a rotational direction of the motor MDR for the coupling device.

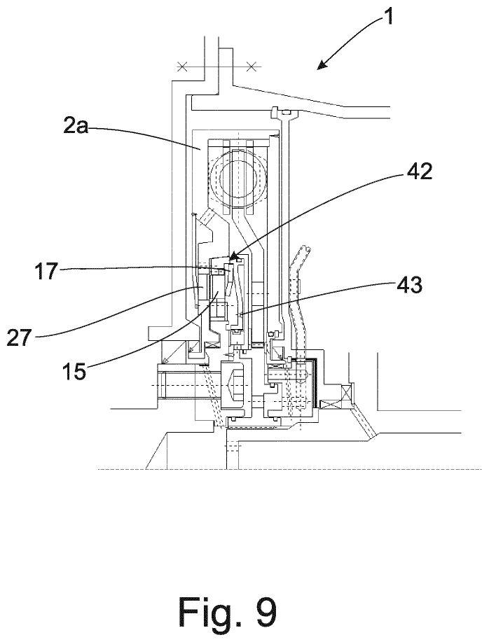

FIG. 9 shows a damping device according to a further embodiment form of the present invention.

FIG. 9 basically shows a damping device 1 according to FIG. 5. In the damping device 1 according to FIG. 9, in contrast to the damping device 1 according to FIG. 5, instead of forming the friction cone 14 and ratchet wheel 15 itself as piston, a corresponding piston 42 is now arranged for actuating ratchet wheel 15 and friction cone 14. The piston 42 presses on the friction cone 14 in the area of the primary plate 2a. A plate spring 17 pushes the ratchet wheel 15 into the closed position. Oil for actuating the piston 42 can flow via a piston nozzle 43 into the oil pressure chamber of the spring set 4 and hub disk 6. In order to cancel the coupling of ratchet wheel 15, friction cone 14 and primary plate 2a again, the oil is correspondingly rerouted and the piston 42 returns to its initial position, wherein the plate spring 17 is pressed back by the ratchet wheel 15.

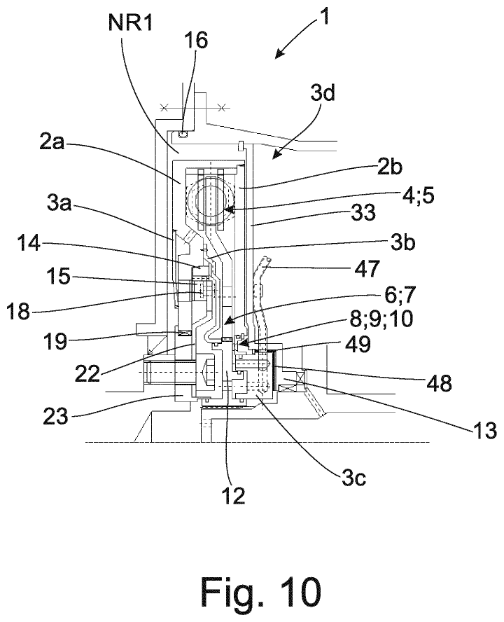

FIG. 10 shows a damping device according to a further embodiment form of the present invention.

FIG. 10 basically shows a damping device 1 according to FIG. 1. In the damping device 1 according to FIG. 10, in contrast to the damping device 1 according to FIG. 1, a spring plate 22 with tangential spring arms is arranged at the crankshaft hub 20 instead of the toothing between ratchet wheel 15 and crankshaft hub 20, which spring plate 22 is fixed to the crankshaft hub 20 by a screw-on plate 23. With the spring arms of spring plate 22, which extend substantially in radial direction, the ratchet wheel 15 is fixed to this spring plate 22 via a rivet connection 18. Further, a cover 3d for forming the torsional damper wet space NR1 is constructed as a bearing shield 33. A receiving borehole 49 is arranged in the bearing shield 33 for receiving a connection 47. Connection 47 can be formed for receiving a hydraulic hose and/or a pipe line for a hydraulic fluid, for example, from a separate valve block in the bell housing or the like. Further, a rubberized intermediate layer 48 is arranged as compensation element for movements of the crankshaft.

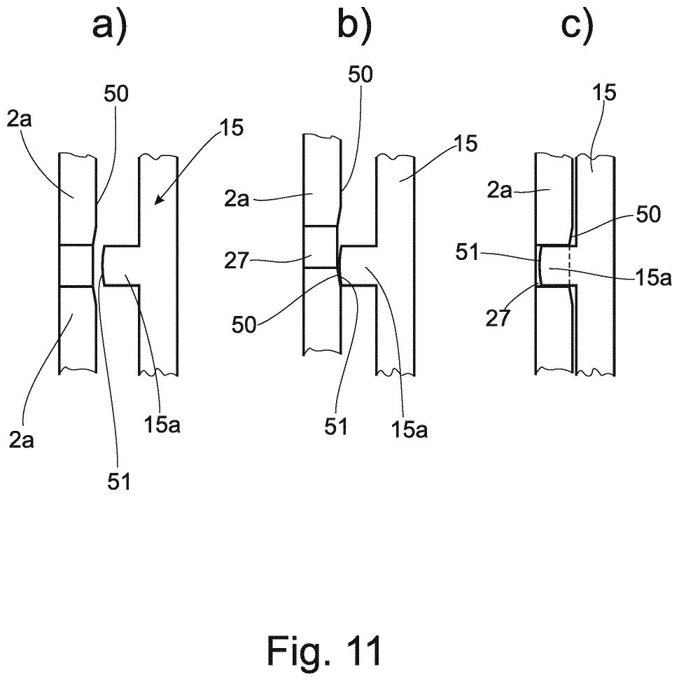

FIGS. 11a, 11b and 11c show various conditions and configurations of the coupling device according to a further embodiment forms of the invention.

The coupling device is shown in the open position in FIG. 11a, running against a bevel in FIG. 11b, and in the closed position in FIG. 11c.

In FIG. 11a, the pawl 15a of the ratchet wheel 15 does not engage in the cutouts 27 of primary plate 2a. The area around the cutouts 27, i.e., the peripheral area of the cutouts 27 in the direction of the ratchet wheel 15, is provided with a bevel 50. Further, the pawl 15a is likewise provided with a bevel 51 which extends substantially under the same angle as the bevel 50 of pawl 15a.

In FIG. 11b, the ratchet wheel 15 now runs against the bevel 50 of the primary plate 2a with its pawl 15a, but does not engage in cutouts 27.

FIG. 11c shows the condition of the coupling device with pawls 15a engaging in the cutouts 27.

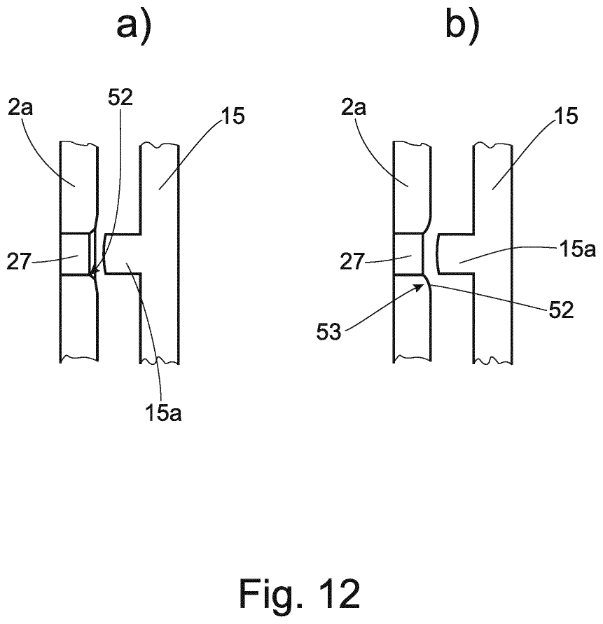

FIGS. 12a and 12b show coupling devices according to further embodiment forms of the present invention.

FIG. 12a basically shows the arrangement of primary plate 2a and ratchet wheel 15 according to FIG. 11 a. In the ratchet wheel 15 according to FIG. 12a, in contrast to the primary plate 2a according to FIG. 11a, the edge 52 is now rounded behind the beveled area 50, particularly in the form of a tractrix 53, which would result due to wear on soft parts.

FIG. 12b again shows a primary plate 2a according to FIG. 11a. In contrast to the bevel 50 of the primary plate 2a of FIG. 11a, the primary plate 2a of FIG. 12b now has a rounded area, for example, in the form of a curve. In other words, the engaging edge 52 does not have a bevel but rather only a rounded area 53.

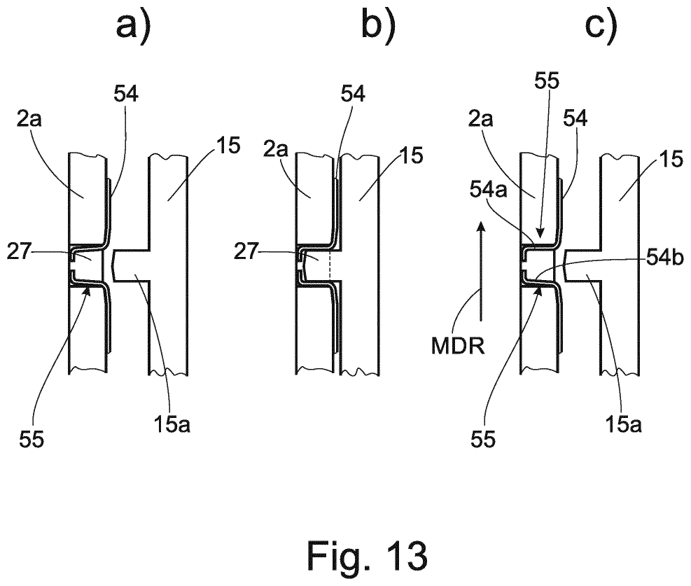

FIGS. 13a, 13b and 13c show coupling devices according to further embodiment forms of the present invention in various conditions.

FIG. 13a basically shows the coupling device 1 according to FIG. 11a. In the coupling device according to FIG. 13a (open coupling device) and FIG. 13b (closed coupling device), in contrast to the coupling device 1 according to FIG. 11a, a spring element in the form of a spring plate 54 is now arranged on primary plate 2a and in cutouts 27. The spring element 54 has a flat-tapering angle 55 in the cutouts 27 of the primary plate 2a for backlash-free force transmission. In contrast to the embodiment forms in FIGS. 13a and 13b, FIG. 13c shows an asymmetrically formed spring element 54 with planar contact on the drive side 54a and flat spring angle 55 on the coast side 54b based on the rotational direction of the motor MDR.

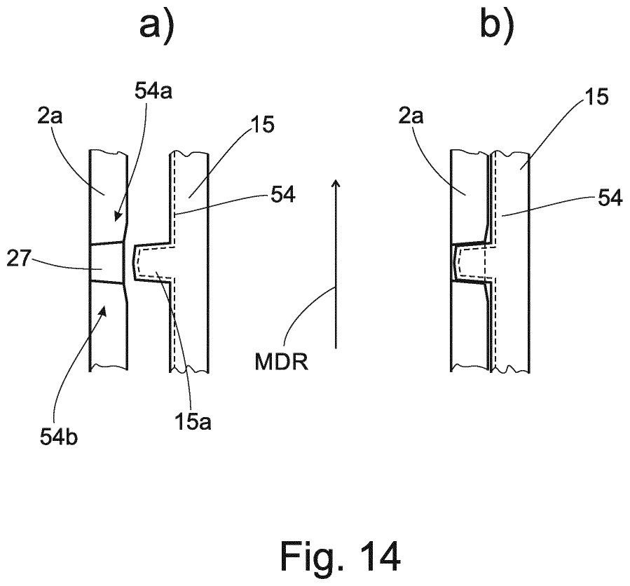

FIGS. 14a and 14b show a coupling device in the open condition and closed condition according to a further embodiment form of the present invention.

In FIGS. 14a and 14B, the cutouts 27 in the primary plate 2a and the pawls 15a of the ratchet wheel 15 are formed asymmetrically. In this case, the drive side 54a is formed in a planar manner with respect to the rotational direction of the motor MDR and the coast side 54b is beveled, the bevel being configured such that the cutout 27 increases in diameter in direction of the ratchet wheel 15. A further alternative embodiment form is shown in dashed lines. In this further alternative embodiment form, a spring plate 54 is arranged at the ratchet wheel 15 and/or a spring plate can be arranged at the primary plate 2a. The advantage of these embodiment forms consists in a toothing that is free from backlash or at least has minimal backlash. Further, axial restoring forces result from the bevel only from smaller coasting torque.

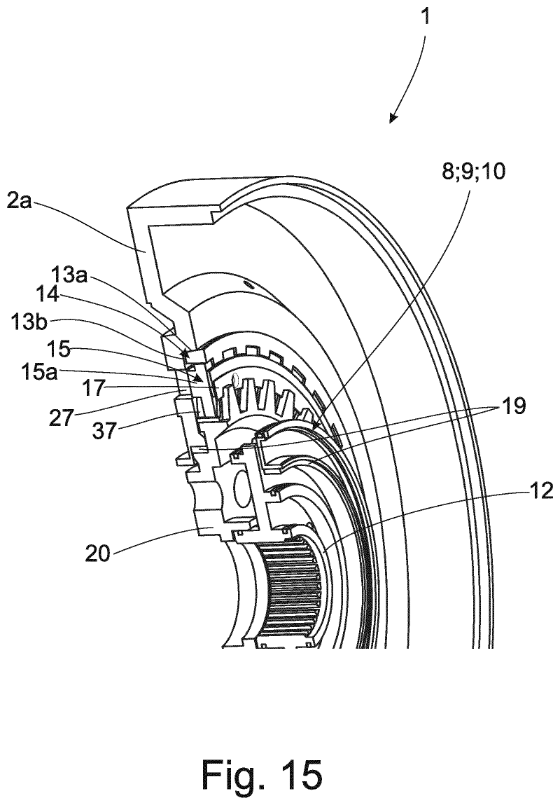

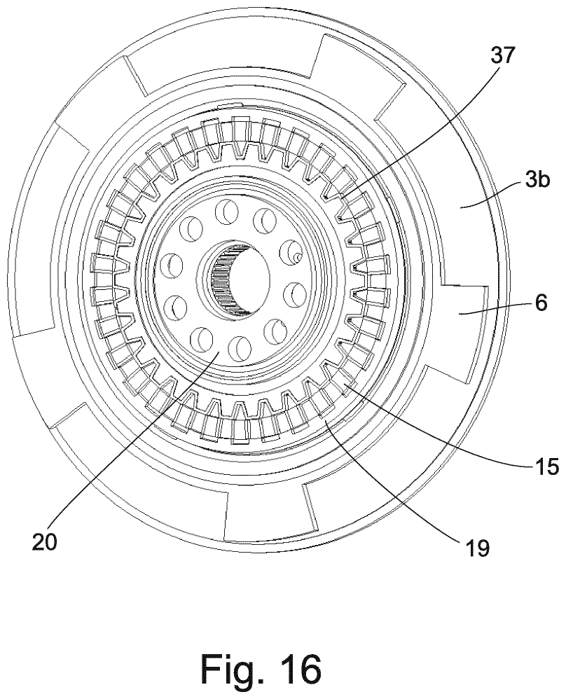

FIG. 15 shows a three-dimensional depiction of parts of the damping device in open position of the coupling device according to a further embodiment form of the present invention, and FIG. 16 is a three-dimensional depiction of parts of the damping device in closed position according to a further embodiment form of the present invention.

FIGS. 15 and 16 basically show a part of a damping device 1 according to FIG. 1 in three-dimensional form. Radially from inside to outside, the crankshaft hub 20 is shown first with its outer toothing engaging in an inner toothing of the ratchet wheel 15. A corrugated spring 37 is arranged between the inner toothing of the ratchet wheel 15 and the outer toothing of the crankshaft hub 20. As in FIG. 1, pawls 15a of the ratchet wheel 15 are arranged opposite cutouts 27 of the primary plate 2a. The primary plate 2a is supported at the crankshaft hub 20 via a sliding bearing 19. An outer toothing which engages in an inner toothing of a friction cone 14 is arranged on the radial outer side of the ratchet wheel 15. When the coupling device is actuated, the friction cone 14 is connected at least partially in a frictionally engaging manner to a radial inner side 13a of the primary plate 2a but not to an axial inner side 13b. The motor-side cover 3a and the primary plate 2a are hidden in FIG. 16.

In summary, the invention and, in particular, embodiment forms thereof show a simple, compact and economical coupling device for a fast start of an internal combustion engine through transmission of torque from a rotating flywheel mass to a crankshaft. Further, the speed difference between SUE and ratchet wheel can be adjusted in a very precise manner, which allows a particularly reliable and defined coupling engagement. A further advantage consists in that few component parts are required, particularly when the ratchet wheel and friction cone themselves are formed as piston for pressure actuation.

Further, embodiment forms of the invention allow a toothing which is free from backlash or at least has minimal backlash, a transmission of force, a simple production, tolerance compensation and a damped engagement impact of the ratchet wheel in the SUE, which prolongs service life.

While the present invention has been described with reference to preferred embodiment examples, it is not limited to these embodiment examples but rather may be modified in various ways. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-30. (canceled)

31. A coupling device configured to transmit a torque from a flywheel mass to a drive device, comprising:
a ratchet wheel having pawls;
a flywheel mass ‘SUE’ having cutouts; and
a transmission element of the flywheel mass ‘SUE’, which is substantially identical to the flywheel mass or is connected to the flywheel mass;
wherein the ratchet wheel and the transmission element of the flywheel mass ‘SUE’ are axially displaceable relative to one another such that the pawls of the ratchet wheel can be moved into cutouts of the SUE; and
a friction device, configured as a friction cone, configured to be connected to the SUE at least partially in a frictionally engaging manner and connected to the ratchet wheel in a positively engaging manner.

32. The coupling device according to claim 31, further comprising:
an actuating device having a piston and a spring device for the piston and configured to reduce an axial distance between the ratchet wheel and the SUE.

33. The coupling device according to claim 32, wherein the piston is actuatable by hydraulic pressure, wherein a piston nozzle is arranged for the piston, and the piston is arranged to contact the friction cone for transmission of force.

34. The coupling device according to claim 31, wherein ratchet wheel and/or friction device is configured for actuation by hydraulic pressure.

35. The coupling device according to claim 31, further comprising:
spring elements having first areas arranged between the pawls and the cutouts of the SUE,
wherein a shape of the spring elements is configured to receive the pawls.

36. The coupling device according to claim 35, wherein the spring elements have second areas arranged between friction device and SUE.

37. The coupling device according to claim 35, wherein the spring elements are arranged on a SUE side.

38. The coupling device according to claim 35, wherein the spring elements extend at least partially under a flat angle relative to at least one of respective lateral surfaces of the pawls and/or respective lateral surfaces of respective cutouts.

39. The coupling device according to claim 38,
wherein the spring elements are formed asymmetrically,
wherein the spring elements extend at a flat angle on a side directed away from a rotational direction.

40. The coupling device according to claim 31, wherein a surface region of the SUE surrounding a cutout is beveled.

41. The coupling device according to claim 40, wherein the surface region surrounding the cutout is rounded at a transition between surface region and the cutout, particularly on a side directed away from a rotational direction.

42. The coupling device according to claim 31, wherein the cutouts and the pawls are configured to correspond to one another but so as to be asymmetrical.

43. The coupling device according to claim 31, wherein the SUE is supported by at least one sliding bearing.

44. The coupling device according to claim 43, wherein the at least one sliding bearing provides a pressure restriction effect and/or the at least one sliding bearing is a combined rolling bearing/rectangular seal.

45. The coupling device according to claim 31, wherein respective areas on both sides of the ratchet wheel are configured to be acted upon by different pressure of a hydraulic fluid, wherein the respective areas are constantly acted upon by a minimum pressure of a hydraulic fluid.

46. A damping device comprising:
a housing;
a coupling device configured to transmit a torque from a flywheel mass to a drive device, comprising:
a ratchet wheel having pawls;
a flywheel mass ‘SUE’ having cutouts; and
a transmission element of the flywheel mass ‘SUE’, which is substantially identical to the flywheel mass or is connected to the flywheel mass;
wherein the ratchet wheel and the transmission element of the flywheel mass ‘SUE’ are axially displaceable relative to one another such that the pawls of the ratchet wheel can be moved into cutouts of the SUE; and
a friction device, configured as a friction cone, configured to be connected to the SUE at least partially in a frictionally engaging manner and connected to the ratchet wheel in a positively engaging manner;
a first damping device configured as a torsional damper;
a drive transmission element configured as a crankshaft hub; and
an output transmission element configured as a hub disk,
wherein the SUE is configured as a primary plate of the damping device.

47. The damping device according to claim 46, further comprising a spring element arranged between the ratchet wheel of the coupling device and the drive transmission element.

48. The damping device according to claim 47, wherein the spring element is configured as a radial shaft spring plate.

49. The damping device according to claim 46, wherein the SUE has a rotary seal, configured as a radial shaft sealing ring, for sealing relative to the drive transmission element.

50. The damping device according to claim 46, wherein the housing is at least partially formed by a vertical wall of a drive mechanism, wherein the vertical wall has a rotary seal for sealing.

51. The damping device according to claim 50, wherein the housing is at least partially formed by a bell housing which is connected to the vertical wall of the drive device, wherein a seal is at least partially arranged between vertical wall of the drive device and bell housing.
